(19) United States
(12) Patent Application Publication
(10) Pub. No.: US 2025/0067945 A1
(43) Pub. Date: Feb. 27, 2025

(54) NON-HERMETIC PACKAGE HAVING INTERNAL TEMPERATURE CONTROL

(71) Applicant: Infinera Corporation, San Jose, CA (US)

(72) Inventor: John W. Osenbach, Kutztown, PA (US)

(73) Assignee: Infinera Corporation, San Jose, CA (US)

(21) Appl. No.: 18/806,933

(22) Filed: Aug. 16, 2024

Related U.S. Application Data
(60) Provisional application No. 63/534,105, filed on Aug. 22, 2023.

(51) Int. Cl. G02B 6/42; G01K 7/25; G05D 23/24

(52) U.S. Cl. CPC G02B 6/4271; G01K 7/25; G05D 23/24

(57) ABSTRACT

Consistent with an aspect of the present disclosure, a thermistor is provided in a pluggable module package to sense the temperature inside such package. A control circuit coupled to the thermistor activates a heater, also in the package, when the temperature inside the package falls below a predetermined value. As a result, the temperature within the package may be adjusted to reduce humidity and condensation to thereby prevent corrosion within the package. Moreover, a less expensive non-hermetic package, which is susceptible to moisture intrusion, may be employed.

### BACKGROUND

The field of optical communications involves pluggable optical modules and controlling the temperature within such modules.

### SUMMARY

In some implementations, an optical component package includes a housing; a substrate disposed within the housing; a resistive heater thermally coupled to a photonic integrated circuit disposed on the substrate; a thermistor configured to measure a temperature of the photonic integrated circuit; and a control circuit electrically coupled to the resistive heater and the thermistor and configured to regulate temperature of the photonic integrated circuit based on feedback from the thermistor.

### BRIEF DESCRIPTION OF THE DRAWINGS

FIG. 1 shows an example of a perspective view of a housing or package consistent with an aspect of the present disclosure.

FIG. 2 shows an example of a plan view of a housing or package including a transmitter photonic integrated circuit (PIC) consistent with a further aspect of the present disclosure.

FIG. 3 shows an example of a plan view of a housing or package including a transceiver PIC consistent with an additional aspect of the present disclosure.

### DETAILED DESCRIPTION

The following detailed description of example implementations refers to the accompanying drawings. The same reference numbers in different drawings may identify the same or similar elements.

Pluggable optical transceiver modules are known that transmit optical signals over fibers at data rates of at least 400 Gbit/second. These transceiver modules incorporate optical components and integrated circuits within a common housing to facilitate transmission of such optical signals. Electrical connections between these components typically have a controlled impedance to minimize signal degradation and reflections. However, high-frequency signal transmission introduces unique challenges related to the physical construction and materials used within optical transceiver modules. Finely spaced conductive traces, having such controlled impedance, may be provided on low-cost organic substrates. However, such substrates are susceptible to moisture ingress into the module. As a result, the optical components and integrated circuits, as well as conductive connections, within the module may be subject to moisture-induced corrosion within the module housing. Accordingly, conventional hermetic housing have been deployed to limit moisture ingress into the package. Such hermetic housings, however, are expensive. There is a need, therefore, to provide a low cost module housing with low component and circuit corrosion.

Some implementations described herein provide a low-cost non-hermetic pluggable optical transceiver modules. For example, the optical component package comprises a housing containing a substrate; a resistive heater thermally coupled to a photonic integrated circuit disposed on the substrate; a thermistor configured to measure the temperature of the photonic integrated circuit; and a control circuit electrically coupled to the resistive heater and the thermistor. The control circuit is configured to regulate the temperature of the photonic integrated circuit based on feedback from the thermistor, thus maintaining a consistent operating temperature and preventing condensation and corrosion. In some aspects, the heater is activated by the control circuit when the temperature falls below a predetermined range (e.g., 40C to 45C). The control circuit is electrically coupled to the resistive heater to prevent the temperature within the housing from reaching a level that would allow condensation to form. When the temperature detected by the thermistor is above this range, the control circuit can either deactivate the heater or reduce the current or voltage supplied to it in order to lower or maintain the temperature within the non-hermetic housing above that which condensation may occur. Consistent with the present disclosure, therefore, moisture-induced corrosion within a non-hermetic optical transceiver modules can be achieved by maintaining the internal temperature above that which condensation occurs. This innovation ensures the optical transceiver modules maintain high-speed data transmission capabilities without moisture-related reliability issues in a low-cost non-hermetic package. By allowing for the use of cost-effective organic materials, manufacturing costs are reduced and reliability may be improved.

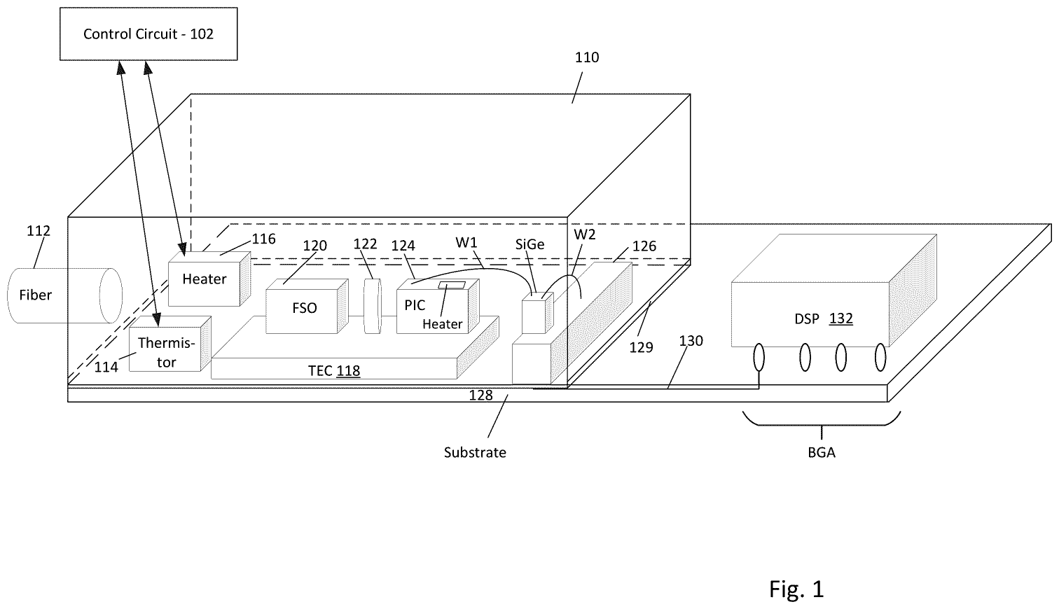

Referring now to FIG. 1, a detailed description of an optical component package is provided in accordance with the claimed invention. The optical component package comprises a housing denoted as 110, which may be made of a low-cost organic material that is permeable to moisture, for example. Within this housing 110, a substrate 128 is disposed to provide mechanical support and thermal conduction for a photonic integrated circuit (PIC) 124 positioned thereon. In addition, the housing 110 may be attached to substrate 110 by way of a seal 129, which, in one example, includes an organic polymer, which may also be permeable to moisture. In another example, housing 110 may be made of a non-organic material that is relatively impervious to moisture, however, in this further example, organic polymer seal 129 is provided to minimize costs, as noted above.

In one example, a resistive heater 116 is thermally coupled to the PIC 124, configured to maintain the PIC and other components and circuits within housing 110 within a desired temperature range that prevent condensation within housing 110. The resistive heater 116 functions in concert with a thermistor 114, which is positioned within housing 110 to measure the temperature within housing 110. In one example, the resistance of thermistor 114 changes in accordance with the temperature within housing 110. Such resistance may be detected, and thus the temperature, by control circuit 102 by detecting a change in current through the thermistor or a change in a voltage drop across thermistor 114 as the temperature changes.

Accordingly, when control circuit 102 detects a drop in temperature within housing 110, an additional current or voltage is applied to heater 116 to thereby increase the temperature within housing 110. Thus, control circuit 102 is configured to regulate the temperature within based on feedback from the thermistor 114. When the thermistor 114 detects a temperature above the predetermined threshold, the control circuit 102 is further configured to sense such elevated temperature deactivate the resistive heater 116 by reducing the current and voltage supplied to heater 116 to thereby prevent overheating.

As further shown in FIG. 1, PIC 124, which may include an indium phosphide substrate, may include integrated modulators for supplying modulated optical signals. PIC 124 is optically coupled to an optical fiber 112 through a lens 122 aligned with the PIC 124. The lens array 122 is disposed on the substrate 128 to direct the modulated optical signals to optical fiber 112 by way of lens 122 and free space optics (“FSO”) 120. An additional heater may be provided on PIC 124 to facilitate tuning of the wavelength of the modulated optical signals output from the PIC.

Additionally, electrical wires W1 and W2 are disposed within the housing 110 to provide electrical connectivity to the PIC 124. These wires are part of an electrical system that includes a driver circuit provided in a silicon germanium (SiGe) application specific integrated circuit application specific integrated circuit (ASIC), electrically coupled to the modulators in PIC 124. Namely, the driver circuit supplies a drive signal to the modulators in the PIC by way of wire W2.

FIG. 1 also illustrates a thermoelectric cooler (TEC) 118 placed adjacent to the PIC 124 to further aid in temperature control. Moreover, a digital signal processor (DSP) 132, which may or may not be part of the same printed circuit board assembly, can be electrically connected to the SiGe via conductors 130, ensuring a controlled impedance for high-speed data transmission. DSP 132 may provide electrical signals carrying data to the SiGe ASIC. As further shown in FIG. 1, a ball grid array (BGA) may be provided to supply such electrical signals to a conductors 130 which extend into housing 110 and connect with wire W2, for example, which, in turn, is connected to the SiGe ASIC.

An integrated ledge 126 may be provided as a structural element within the housing 110 for support or alignment purposes.

In summary, the optical component package shown in FIG. 1 provides a controlled environment for high-speed optical data transmission, using various elements such as the housing 110, optical fiber 112, thermistor 114, resistive heater 116, TEC 118, lens 122, PIC 124, wires W1 and W2, SiGe, ledge 126, substrate 128, conductor 130, DSP 132, control circuit 102, and optionally BGA, all coordinated to achieve stable operation and mitigate the effects of environmental factors such as temperature and humidity.

As indicated above, FIG. 1 is provided as an example. Other examples may differ from what is described with regard to FIG. 1.

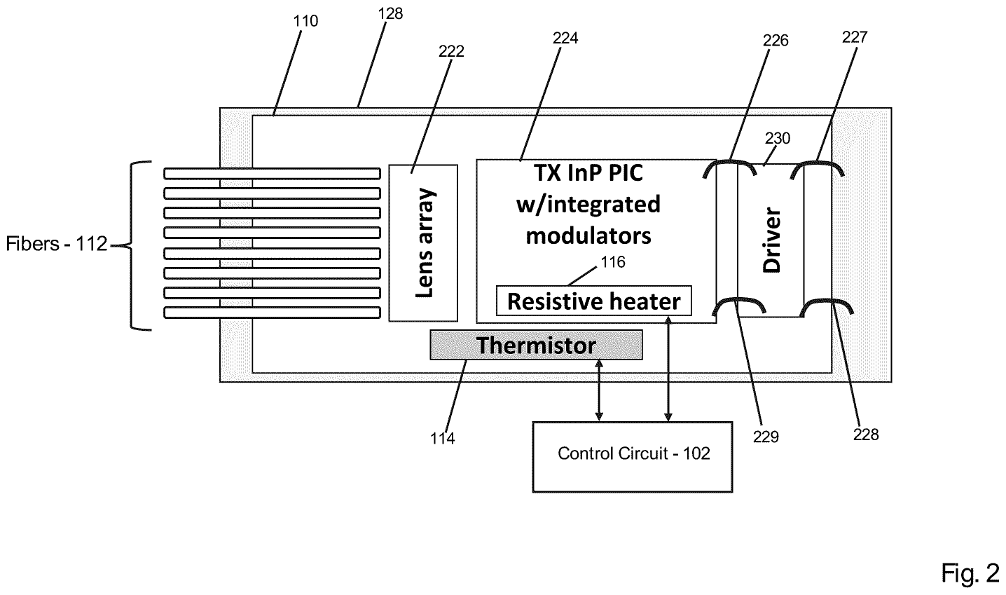

Referring now to FIG. 2, there is illustrated another embodiment of an optical component package exemplifying the principles of the present disclosure. The optical component package comprises a housing 110 designed as a non-hermetic enclosure to provide a protective environment for the integral components housed within it. Within housing 110, there are numerous critical components including substrate 128, photonic integrated circuit (PIC) 224, resistive heater 116, thermistor 114, control circuit 102, lens array 222, driver circuit 230, and electrical wires 226, 227, 228, and 229.

Substrate 128 is positioned within housing 110 to provide mechanical support and thermal conduction for the photonic integrated circuit. This substrate plays a pivotal role in maintaining the stability and functionality of the internal components.

On substrate 128, a photonic integrated circuit, specifically a transmitter indium phosphide (TX InP PIC) with integrated modulators 224, is positioned.

Thermally coupled to the TX InP PIC 224 is resistive heater 116, which ensures that the photonic integrated circuit maintains a consistent operating temperature. Located in close proximity to the TX InP PIC 224 is thermistor 114. The thermistor is configured to measure the temperature of the PIC accurately, providing immediate and precise temperature readings that are essential for maintaining consistent performance.

Control circuit 102 is electrically connected to both resistive heater 116 and thermistor 114. It regulates the temperature of the photonic integrated circuit based on the feedback from thermistor 114. When thermistor 114 detects a temperature below a predetermined threshold, the control circuit activates resistive heater 116 to heat the PIC to maintain its operational temperature. Conversely, when the temperature exceeds the threshold, the control circuit deactivates the resistive heater to prevent overheating in a manner similar to that described above.

The optical component package further includes an optical fiber array represented as fibers 112. These fibers are optically coupled to the TX InP PIC 224 and are designed to transmit.

Additionally, driver circuit 230 is electrically coupled to the TX InP PIC 224. The driver circuit provides the necessary electronic components for biasing the PIC, which helps in the proper functioning of the PIC and its integrated modulators.

Lens array 222 is disposed on substrate 128 and aligned with the TX InP PIC 224 to direct optical signals accurately, enhancing the efficiency of signal transmission.

To ensure necessary electrical connectivity, electrical wires 226, 227, 228, and 229 are disposed within housing 110. These wires establish the essential electrical connections between the PIC and external circuits or systems.

In summary, FIG. 2 illustrates an arrangement of components within housing 110 similar to that described above in connection with FIG. 1. For example, temperature control to prevent moisture-induced corrosion is provided in FIG. 2 similar to that described above. Housing 110 in FIG. 2, however, is connected to multiple optical fibers 112 to thereby transmit multiple modulated optical signals from PIC 224.

As indicated above, FIG. 2 is provided as an example. Other examples may differ from what is described with regard to FIG. 2.

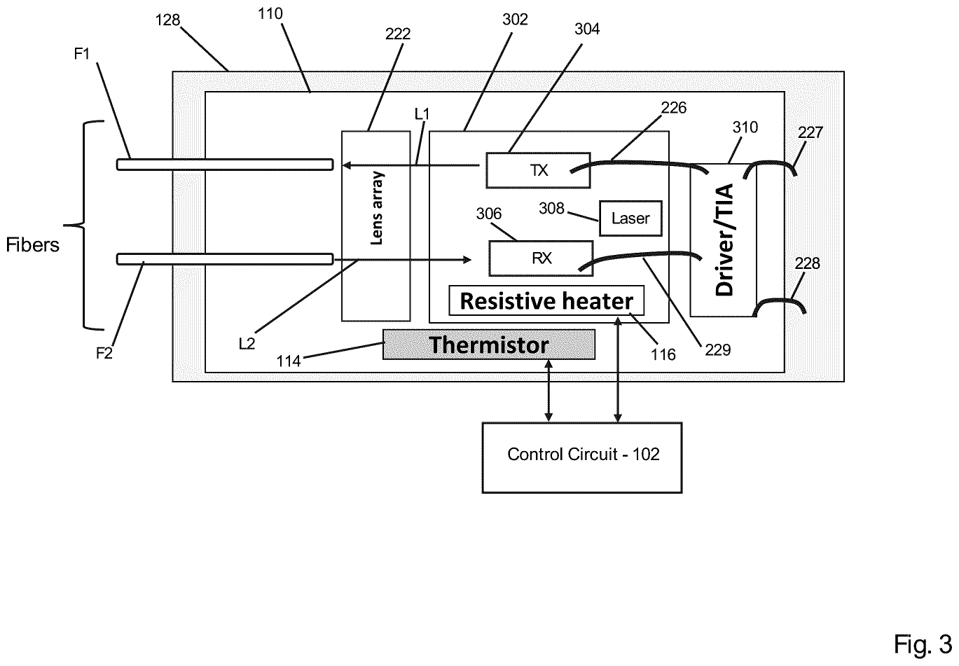

FIG. 3 shows a module similar to that described above in connection with FIGS. 1 and 2. In FIG. 3, however, transceiver PIC 302 is provided that includes a transmitter 304 and a receiver 306. Driver/TIA SiGe ASIC 302 supplies drive signals to modulator in transmitter 304 by way of wire or conductor 226 based on electrical signal received from wire or conductor 227. Transmitter 304, in turn, supplies modulated optical signals L1 to fiber F1 by way of lens array 222.

In addition, incoming or received optical signals L2 are input to housing 110 by way of optical fiber F2. Such optical signals are supplied to receiver 306 via lens array 222. Receiver 306 includes photodiodes, which, in turn, generate corresponding electrical signals that are supplied to driver/TIA SiGe ASIC 310 by way of wire 229. Driver/TIA SIGE ASIC 310 includes transimpedance amplifiers (TIAs) in addition to driver circuitry. The TIAs supply amplified versions of the photodiode outputs via wire 228.

As further shown in FIG. 3, housing 110 includes a resistive heater 116 and thermistor 114, as well as a control circuit, which are coupled to one another and operate in a manner similar to that described above to maintain the temperature in housing 110 to prevent condensation and moisture-induced corrosion.

Consistent with a further aspect of the present invention, and in one example, maintaining the temperature within housing 110 to be within a range of 40 to 45 degrees Celsius has been found to be sufficient to prevent condensation and moisture-induced corrosion, on the one hand, and sufficient to permit operation of the optical and electrical components within housing 110 without overheating.

The non-hermetic nature of the housing allows for a reduction of the overall cost of the device while still effectively managing humidity and temperature to prevent corrosion within the package. As a result, the housing and seal noted above may be made of low cost organic material, thereby reducing the overall cost of the module.

As indicated above, FIG. 3 is provided as an example. Other examples may differ from what is described with regard to FIG. 3.

The foregoing disclosure provides illustration and description, but is not intended to be exhaustive or to limit the implementations to the precise forms disclosed. Modifications may be made in light of the above disclosure or may be acquired from practice of the implementations.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An optical component package, comprising:
a housing;
a substrate disposed within the housing;
a resistive heater thermally coupled to a photonic integrated circuit disposed on the substrate;
a thermistor configured to measure a temperature of the photonic integrated circuit; and
a control circuit electrically coupled to the resistive heater and the thermistor and configured to regulate temperature within the housing based on feedback from the thermistor.

2. The optical component package of claim 1, wherein the housing defines a non-hermetic enclosure for the substrate, the photonic integrated circuit, the resistive heater, the thermistor, and the control circuit.

3. The optical component package of claim 1, wherein the resistive heater is configured to maintain the photonic integrated circuit at a consistent operating temperature.

4. The optical component package of claim 1, wherein the thermistor is positioned in close proximity to the photonic integrated circuit for accurate temperature sensing.

5. The optical component package of claim 1, further comprising an optical fiber optically coupled to the photonic integrated circuit.

6. The optical component package of claim 5, wherein the optical fiber is configured to transmit or receive optical signals.

7. The optical component package of claim 1, wherein the control circuit is further configured to activate the resistive heater when the thermistor detects a temperature below a predetermined threshold.

8. The optical component package of claim 1, wherein the control circuit is operable to control the temperature within the housing to be within a desired range.

9. The optical component package of claim 1, further comprising a driver circuit electrically coupled to the photonic integrated circuit and configured to supply a drive signal to a modulator that provides a modulated optical signal.

10. The optical component package of claim 9, wherein the driver circuit includes electronic components for biasing the photonic integrated circuit.

11. The optical component package of claim 1, wherein the photonic integrated circuit includes integrated modulators for optical signal modulation.

12. The optical component package of claim 1, further comprising a lens array disposed on the substrate and aligned with the photonic integrated circuit for directing optical signals.

13. The optical component package of claim 1, wherein the control circuit is further configured to deactivate the resistive heater when the thermistor detects a temperature above a predetermined threshold.

14. The optical component package of claim 2, further comprising electrical wires disposed within the housing and providing electrical connectivity to the photonic integrated circuit.

15. The optical component package of claim 1, wherein the substrate is configured to provide mechanical support and thermal conduction for the photonic integrated circuit.

16. The optical component package in accordance with claim 8, wherein the desired range is 40 degrees to 45 degrees Celsius.
